(19) United States
(12) Patent Application Publication
(10) Pub. No.: US 2020/0281808 A1
(43) Pub. Date: Sep. 10, 2020

(54) INSERTABLE STIMULATION DEVICE

(71) Applicant: NOVOLUTO GmbH, Berlin (DE)

(72) Inventors: Enrico Kirsten, Berlin (DE); Mark Tobias Zegenhagen, Berlin (DE); Árpád Körmendy, Berlin (DE)

(21) Appl. No.: 16/811,907

(22) Filed: Mar. 6, 2020

(30) Foreign Application Priority Data
Mar. 7, 2019 (EP) 19161328.0

(51) Int. Cl. A61H 21/00; A61H 23/04

(52) U.S. Cl. CPC A61H 21/00; A61H 23/04

(57) ABSTRACT

An example stimulation device for stimulation of an area inside a human body includes a first portion configured to at least partially be inserted into the human body, a pressure field generation device configured to generate a pneumatic pressure alternating field, and a pressure chamber coupled with the pressure field generation device, the pressure chamber configured to accommodate a pressure alternating field generated by the pressure field generation device. The pressure chamber is disposed in the first portion and includes an opening formed in the first portion, the pressure alternating field in the pressure chamber to be applied via the opening to the area to be stimulated inside the human body.

### RELATED APPLICATION

This patent arises from a U.S. patent application that claims the benefit of, and priority to, European Patent Application No. EP 19161328.0, filed Mar. 7, 2019. European Patent Application No. EP 19161328.0 is hereby incorporated herein in its entirety.

### FIELD OF THE DISCLOSURE

The invention relates to a stimulation device for an area inside a human body. The stimulation device can be inserted into a human body, in particular, into a vagina or a rectum, and has a pressure field generation device in order to stimulate an area to be stimulated inside the human body by means of a pneumatic pressure alternating field.

### BACKGROUND

Insertable stimulation devices are known that can at least partially be inserted into the interior space of a human body for stimulation. In particular, such devices are known, which can be inserted into a natural body opening, such as a vagina or a rectum, and are dimensioned and shaped according to the respective anatomy. In particular, the stimulation of various areas inside the female or male body can lead to sexual arousal leading all the way to sexual climax. Various devices are therefore known to reach and to stimulate the desired areas by means of manually moving the device or, for example, by means of electrically generated tactile stimulation, such as vibration.

Possible erogenous zones of the female body include areas inside the vagina, which colloquially, for example, as a G-spot or G-zone (zone located on the anterior wall of the vagina), Azone (zone in the abdominal area of the recess of the cervix known as the anterior fornix) or O-zone (zone in the rear area of the recess of the cervix in the direction of the rectum known as the posterior fornix). Vaginal erogenous zones are interspersed with numerous nerve endings and can be stimulated for sexual arousal, although sensitivity can also vary greatly from woman to woman. In addition to the inner clitoris, the pelvic floor muscles and the cervix are also among the erogenous zones of the female body, which can be stimulated across the inside of the vagina.

In addition to the penis, one of the strongest erogenous zones of the male body is the prostate. The prostate can be reached through the rectum and can be touched and stimulated via the intestinal wall. The invasive stimulation of the prostate via the rectum can achieve a sexual climax that differs from the phallically stimulated sexual climax with regard to type and intensity.

### SUMMARY

The object of the present invention is to create an insertable stimulation device, which provides an improved type of stimulation of an area to be stimulated inside a human body.

The task is achieved by means of a stimulation device with the features of independent Claim 1. Further developments and preferred embodiments are specified in the dependent claims.

According to the invention, a stimulation device is provided for stimulation of an area inside a human body. The stimulation device comprises at least a first portion, which is configured to be at least partially inserted into a human body. The stimulation device also comprises a pressure field generation device, which is configured to generate a pneumatic pressure alternating field. Furthermore, at least one pressure chamber is provided, which is coupled with the pressure field generation device and is configured to accommodate a pressure alternating field generated by the pressure field generation device. The pressure chamber is arranged in the first portion of the stimulation device and has at least one opening, which is also formed in the first portion. The first portion, the pressure chamber and the opening are configured so that a pressure alternating field in the pressure chamber can be applied via an opening to an area to be stimulated in the inside of the human body.

Thereby, the stimulation device can be called an insertable stimulation device and the first portion can be called an insertable portion or an “insertion portion”, wherein the first portion is configured to be inserted, in particular, into a natural body opening, such as a vagina or a rectum. In particular, the shape and size of the first portion are selected in order to make an insertion possible or also to facilitate it and, on the other hand, not to make it more difficult, or at least not prevent it, for example, by avoiding large projections, corners or even sharp edges. In other words, the stimulation device, in particular, the insertion portion is designed and dimensioned in such a way in order to be able to be used for insertion into the vagina or into the rectum and to reach and stimulate the corresponding erogenous ones. In particular, at least a partial insertion in terms of the present disclosure therefore comprises a sufficiently deep insertion in order to reach the desired area, meaning placing the opening over the desired area so that this is at least partially covered by the opening and can receive the pressure alternating field.

The stimulation takes place by means of the pressure alternating field via contactless transmission of a stimulation force. In particular, parts of the pressure field generation device, such as a flexible wall or membrane of the pressure field generation device for example, which is accordingly deflected for generating a pressure alternating field, also do not come into contact with the body, particularly not at any phase of operation. In particular, this is favourable for stimulation of sensitive mucous membranes inside of the body. Thereby, a special stimulation effect can thereby be created, which differs from the effect of common tactile stimulation devices, for example, vibrators.

Since the stimulation takes place via a pressure field consisting of the continuous alternation of positive and negative pressures applied to the erogenous zones, the device is designed in such a way that the dimensions of the pressure chamber to be positioned at the desired erogenous zones including the opening are adapted to the vaginal and anal anatomy so that a sufficient air volume can form in the pressure chamber for specific stimulation. In this context, sufficient means that the air volume is not limited by the vaginal wall or the wall of the rectum, which, in particular, can be pulled into the negative pressure phases of the pressure alternating field into the pressure chamber in such a way that the build-up of the pressure field are fully prevented or limited in its geometric dimensions, thereby being inefficient for sexual stimulation.

The first portion can be longitudinally extended along an insertion direction, be straight or also be curved. It can extend from a first front end of the stimulation device in the insertion direction to an opposite second end, which can also be positioned inside the body or also remain outside the body. Depending on the use (vaginal/anal) and the desired area to be stimulated, the first portion can be correspondingly designed and have a matching cross-section, and the pressure chamber and the opening can be accordingly positioned and dimensioned, for example, in a side wall of the insertion portion in order to reach a desired area, for example, an anterior (abdominal-side) wall of a vagina or a rectal wall of the rectum abutting the prostate.

While a sufficient sealing of the pressure chamber against the ambient environment can already take place after insertion due to the mucous membranes around the first portion (“self-sealing effect”), the stimulation device can comprise a sealing device which is formed on the first portion and is configured to seal the pressure chamber against the ambient environment. In particular, the sealing device can be formed around the opening of the pressure chamber in a circumferential manner, corresponding to the shape of the opening, for example, being circular, oval or the like. The sealing device may, for example, have at least a projection or ridge, which forms a circumferential seal for sealing the pressure chamber against the ambient environment.

The sealing device is preferably designed in such a way that this abuts the inner side of the vagina or the rectum after the insertion of the first portion of the device. In this way, the sealing of the pressure chamber and thus the build-up of a pressure alternating field can be improved. This is advantageous to stimulate the area to be stimulated inside the body by means of the pressure alternating field, meaning, in particular, the area which is located in the area of the opening of the pressure chamber directly adjacent to the pressure chamber.

By pressure alternating field, in the context of the present disclosure, such an alternating pressure field is generally understood that comprises both positive pressures as well as negative pressures with respect to the ambient pressure, for example, alternating negative pressure phases and positive pressure phases or, in another specified pattern of, if applicable, the same or different negative pressures and positive pressures. This pressure alternating field prevails in the pressure chamber, particularly in the area of the opening of the pressure chamber, i.e. parameters such as frequency and amplitude of the pressure alternating field must be measured at the opening. The term pressure field or pressure alternating field therefore refers to such a pressure alternating field.

In the inserted state, the pressure chamber is thereby sealed or substantially sealed against the ambient environment, particularly with regard to negative pressures as well as positive pressures relative to an ambient pressure of the ambient environment. In other words, currents, especially air currents, are prevented or at least substantially prevented in both directions, i.e. from the pressure chamber into the ambient environment and from the ambient environment into the pressure chamber. In particular, areas outside of the pressure chamber are portion of the ambient environment.

Thereby, the pressure can alternate with a frequency of 1 Hz to 150 Hz, preferably 1 Hz to 125 Hz, further preferable 1 Hz to 100 Hz, for example, 60 Hz. The pressure difference can be 20 mbar to 600 mbar, preferably, 20 mbar to 400 mbar, further preferable 20 mbar to 300 mbar, for example 200 mbar, wherein the pressure difference exists between the highest positive pressure and the lowest negative pressure and, preferably, is formed symmetrically around an ambient pressure. At a normal pressure of the ambient environment of about 1 bar, the pressure alternating field can, for example, lead to a pressure of 0.7 bar to 1.3 bar in the pressure chamber, which corresponds to a pressure difference of 600 mbar. The stimulation device can comprise a control device, such as a microcontroller, in which the modulation of the pressure field, in particular the frequencies or frequency ranges and/or certain patterns of the pressure field can be pre-stored. Furthermore, at least one control element can be provided, which can be operated by a user in order to select and/or change a modulation of the pressure field.

The pressure alternating field is, in particular, a pneumatic pressure alternating field, i.e. the pressure medium is, in particular, air. However, it is conceivable that the pressure alternating field is transmitted via another medium, for example via a fluid, such as water, gel or even bodily fluid, which enters or is inserted into the pressure chamber. The above-mentioned parameters of the pressure alternating field are preferably suitable and preferred for a pleasant and targeted stimulation for the corresponding erogenous zone, i.e. leading to the sexual climax stimulation. While lower levels are not sufficient for sexual stimulation, higher values can be perceived as unpleasant or even pose a risk of injury to the sensitive mucous membranes.

The opening preferably has a diameter of greater than or equal to 5 mm, preferably, greater than or equal to 7 mm. Thereby, the diameter of the opening is preferably less than or equal to 40 mm, further preferable less than or equal to 30 mm. By diameter, other cross-sectional dimensions of non-circular openings can also be understood. In particular, the mentioned values apply both to a circular opening as well as, for example, to an oval or an elliptical opening. Corresponding values are then assumed for the large half-axis of the ellipse. The same applies to openings having any other shapes, for example other round or angular shapes, wherein, generally, the size of an opening is preferably chosen, in particular, in such a way that the surface of the opening corresponds to the surface of a circular opening within the range of the dimensions mentioned above.

The pressure chamber preferably has a minimum depth of greater than or equal to 3 mm, preferably greater than or equal to 5 mm, further preferable greater than or equal to 7 mm. By minimum depth, the length of the middle flow progression from the opening of the pressure chamber (or a virtual plane defined by the opening of the pressure chamber) in the direction of and up to the pressure field generation device is understood. Since this spacing is not necessarily constant, for example, due to a moveable wall, by minimum depth, the length of the flow thread from the opening of the pressure chamber in the direction of the pressure field generation device in a position of the moveable wall at a minimum volume of the pressure chamber is understood.

The aforementioned dimensions of the pressure chamber and its opening are favourable so that a pressure field required for stimulation can be built up to a sufficient degree after insertion of the device. In particular, a sufficient volume of air can form inside the vagina or rectum at the erogenous zone, at which the stimulation is aimed, which is not limited too much by the vaginal wall or the wall of the rectum.

The opening of the pressure chamber can have the same cross-section as the pressure chamber so that the pressure alternating field can be applied to the area to be stimulated on a surface that is as large as possible. In order to further increase the area on which the pressure alternating field acts, i.e. in particular, the surface of the opening of the pressure chamber, the pressure chamber can expand towards the opening. As an alternative, the pressure chamber can however have a constant cross-section and, for example, be cylindrical.

Vice versa, it can be provided that the cross-section of the pressure chamber becomes smaller towards the opening. For example, independently of this, a cross-section of a channel leading to the pressure chamber can be greater than a cross-section of the pressure chamber and/or of the opening. In this way, the pressure in the area of the opening can be strengthened. Independently of the geometry of the pressure chamber, the opening can have a smaller cross-sectional surface than the area of the pressure chamber abutting the opening.

The pressure field generation device may have a moveable element for pressure field generation, such as a moveable wall or membrane, and a drive unit for causing movement of the moving element. By moving the moveable element, in particular in a closed flow system, a pressure alternating field with the above-described characteristics can be built up, which is suitable for sexual stimulation of an area inside a human body.

In an exemplary embodiment, the drive unit and the moveable element can each be arranged at least partially or completely in the first portion, that is, in that portion of the device which is configured for insertion. For example, the moveable element can be a moving wall that directly limits the pressure chamber so that volume changes in the pressure chamber directly cause a pressure alternating field to be generated.

In addition to the first insertable portion, the stimulation device can comprise a second portion, which is configured to be at least partially arranged outside the human body if the first portion is at least partially inserted into the human body. Thereby, for example, it can be a gripping portion, an operational portion or another portion with or also without other functionality. In particular, in contrast to the first portion, the second portion can be shaped and dimensioned in such a way that it is preferably not insertable or is at least only partially insertable into a human body. Furthermore, alternatively or in addition to the control elements arranged in the second portion, a remote control connected to the stimulation device in a wired or wireless manner can be provided in order to control the generation of the pressure alternating field.

In one exemplary embodiment, the drive unit and the moveable element can each at least be partially arranged in the second portion, wherein the pressure field generation device and the pressure chamber can be fluidically coupled to a cavity via a connecting part. The connecting portion can comprise, for example, a hose, a pipe, a channel or another suitable structure, which has a corresponding cavity or a fluid-conveying lumen for transmitting the pressure alternating field from the pressure generation device to the pressure chamber. Such a spatial separation of the individual components allows the greatest possible flexibility in the shape design of the stimulation device and the build-up of the pressure field generation device. In this way, depending on the arrangement of the components in the first or second portion, a more compact structure of the first and/or second portion can be achieved. For example, the drive can be placed in the portion of the stimulation device that remains outside the body so that the insertable first portion can be designed as compact as possible.

For the coupling of the pressure chamber and the pressure field generation device, a coupling device can be provided, which is configured to transmit the pneumatic pressure alternating field and prevent a fluid flow, in particular, a fluid flow from the opening of the pressure chamber to the pressure field generation device. This can prevent fluids, such as bodily fluids, particles or other contaminants from entering from the opening of the pressure chamber into the pressure field generation device via the pressure chamber and, if applicable, via a connecting portion, in particular, from entering into the drive unit, which could be caused by capillary forces and could only be cleaned with difficulty or not at all. The coupling device thus serves as a backflow seal.

Simultaneously, the coupling device is configured to allow for a transmission of the pressure alternating field from the pressure generation device to the pressure chamber in the opposite direction. For this purpose, the coupling device can have a flexible membrane that is also impermeable to fluid. In particular, the membrane can be impermeable to fluids with any viscosity. However, as an addition or an alternative, a semi-permeable membrane and/or a different filter device can also be provided, which at least stops solids

The membrane can form a separation between two chambers in the coupling device, wherein one of the chambers is located on the side of the membrane facing the pressure field generation device and the other of the chambers on the side of the membrane facing the pressure chamber. The chambers allow for a deflection of the flexible membrane to transmit the pressure alternating field.

In addition to the pressure chamber in the first portion of the stimulation device for stimulating an inner area of the human body, the device can have at least one other device in the second portion for stimulating an area on the outside of the human body. In particular, if the first portion is inserted to stimulate a desired area inside the body, an increase in sexual arousal can be achieved by means of simultaneously stimulating an external area. In addition, or as an alternative, another device can be provided for stimulation of another area inside of the body.

For example, the stimulation device may have at least one second pressure chamber, which can have all or at least parts of the features of the pressure chamber described above. In other words, like the first pressure chamber, this can be configured to receive a pneumatic pressure alternating field from the pressure field generation device or, where applicable, from another pressure field generation device. The second pressure chamber is preferably arranged in the second portion with an opening, which is also formed in the second portion, so that a pressure alternating field can be applied to an area to be stimulated outside the human body via this opening, while the first portion is at least partially inserted into the human body and, preferably, the first pressure chamber with its opening is placed above an area to be stimulated inside the body.

The first and second pressure chambers are preferably arranged relative to each other in such a way that a simultaneous stimulation of an area inside and an area on the outside of the body can be stimulated. For example, the second pressure chamber can be formed for stimulating the clitoris or perineum, i.e. the region between the anus and the external sex organs, as below more detailed for different exemplary embodiment described. As mentioned, a simultaneous stimulation or alternatively a separate stimulation of the respective areas inside the body and on the outside of the body can be carried out by means of the first and second pressure chamber.

Alternatively or in addition to the second pressure chamber, the stimulation device can comprise a tactile stimulation device, such as a vibrating unit that is configured to generate a tactile perceptible excitation, such as a vibration of at least one portion of the stimulation device. Preferably, this unit is arranged in the second portion, meaning in the external portion of the stimulation device. For example, such a vibration of at least one portion of the second portion can be generated in this way.

The first and second portions can be connected to each other in such a way that a relative position of the first and second portions is adjustable relative one another. For example, the first and second portions can be moveable relative to one another so that an angle between the first portion and the second portion is adjustable. In particular, the first portion and the second portion can be connected via an intermediate portion, which provides a corresponding function for setting the relative position of the first and second portion. For example, the intermediate portion can be flexible or have one or a plurality of joints or hinges. Depending on the variant for vaginal or application, the device can be adapted by a user and the various areas to be stimulated can therefore be reached better.

Various variants of the stimulation device can be provided, in particular, for use on the female or the male body. In accordance with an exemplary embodiment, the first portion can be configured to be vaginal, i.e. to be at least partially inserted into a vagina in order to stimulate an area inside a vagina. In accordance with an exemplary embodiment, the first portion can be configured to be inserted anally, meaning to be at least partially inserted into a rectum in order to stimulate an area inside the rectum. According to the application, the device can be appropriately dimensioned and shaped, wherein the opening is, in particular, positioned and dimensioned in such a way that the pressure alternating field can be applied via the opening to an area of an inner wall of the vagina, preferably on an area of an abdominal inner wall of the vagina, or an area of an intestinal wall. The opening of the pressure chamber is preferably arranged in a side wall of the first portion, preferably in an end region of the first portion, wherein the position may differ depending on the type of device.

In particular, in the variant for insertion into a vagina, the first portion and the second portion can be substantially coaxially formed so that, overall, an elongated, phallic shape can result. However, for ergonomic reasons during use, an angle of the first and second portion relative to each other also be desired, for example, at a blunt angle or possibly a curvature of the entire device or at least portion thereof.

Alternatively, the first portion and the second portion may be connected by a possibly curved intermediate portion, so that the first portion and the second portion run at least partially side by side to form a total C, V or U-shape. Preferably, the opening of the pressure chamber in the first portion indicates the second portion so that it can be positioned on an anterior wall inside the vagina, while the second portion is positioned abdominally on the outside in the area of the clitoris. Such a shape of the stimulation device makes various uses possible. For example, a clamping effect can be achieved so that the device can also be used without the use of hands after insertion of the first portion. Independently of this, the first portion can be compact, in particular, relatively flat in order to allow for simultaneous sexual intercourse with a male partner. Thereby, the device can also remain independently in the inserted position by means of a clamping effect or can also be held by hand or by the partner.

In the variant for insertion into a rectum, in particular, of a male body, the opening can be positioned and dimensioned in such a way that the pressure alternating field can be applied via the opening to an area of an intestinal wall of the rectum or rectum, which is located adjacent to the prostate so that the pressure alternating field can at least partially be applied to the prostate via the intestinal wall. While a longitudinally stretched to slightly angled or curved shape is also conceivable in this variant of the stimulation device, the first portion can extend substantially perpendicularly from the second portion to form a T-shape. The second portion prevents a too deep insertion of the device into the rectum, wherein the device can be held in position by the user sitting down. The first portion can have a curvature in order to be able to position of the opening of the pressure chamber near the prostate.

The invention will be explained in the following as an example based on the enclosed drawings. The drawings show for a better understanding of the invention only schematically preferred exemplary embodiments of the invention, wherein the invention is not limited to the preferred exemplary embodiments shown.

### BRIEF DESCRIPTION OF THE DRAWINGS

FIG. 1 shows an insertable stimulation device in accordance with a first exemplary embodiment for stimulation of an inner wall of a vagina.

FIGS. 2 to 9 show schematic cross-sections of variants of the exemplary embodiment from FIG. 1.

FIG. 10 shows an insertable stimulation device in accordance with a second exemplary embodiment for stimulation of an inner wall of a vagina.

FIGS. 11 to 20 show schematic cross-sections of variants of the exemplary embodiment from FIG. 10.

FIG. 21 shows an insertable stimulation device in accordance with a third exemplary embodiment for stimulation of a prostate across the inner wall of a rectum.

FIGS. 22 to 30 show schematic cross-sections of variants of the exemplary embodiment from FIG. 21.

FIG. 31 shows a drive unit of a pressure field generation device.

FIG. 32 shows an electrical drive of a pressure field generation device.

FIG. 33 shows another view of the electrical drive from FIG. 32.

FIG. 34 shows a coupling device for coupling a pressure chamber and a pressure field generation device.

### DETAILED DESCRIPTION

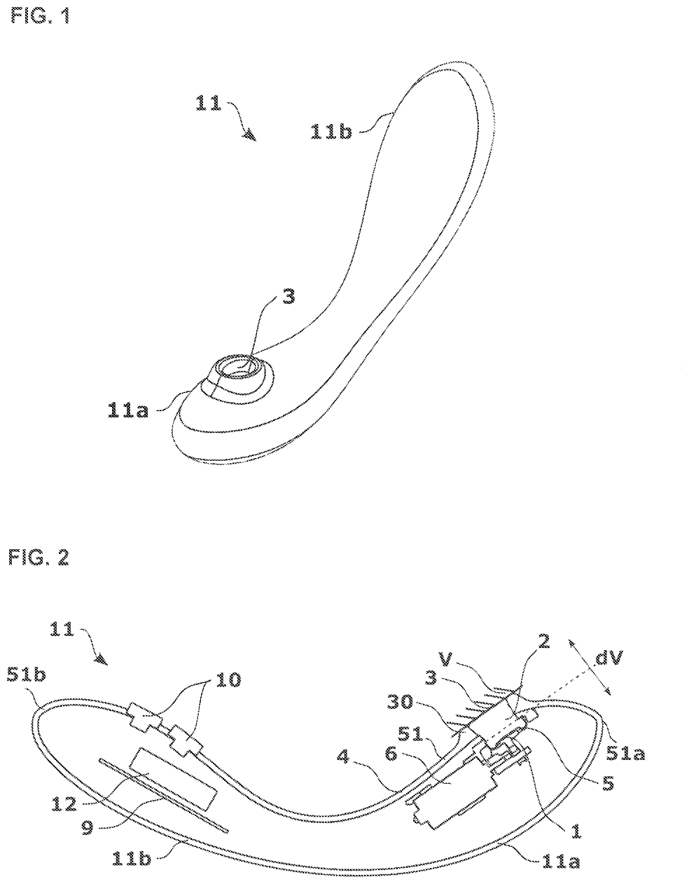

In FIG. 1, a first exemplary embodiment of a stimulation device 11 is shown, which is configured to be at least partially inserted into a vagina for the sexual stimulation of an area inside a vagina. The device 11 has a first portion 11a for insertion and a second portion 11b, which remains outside the body and is used, for example, for holding and operating the device 11. In order to achieve the functionality of the device 11 explained in the following, the first portion 11a must at least be inserted so far into the vagina that the opening 3 is completely placed inside the vagina in order to seal the pressure chamber 2, thereby ensuring a build-up of an appropriate pressure alternating field. The insertable device 11 shown in FIG. 1 is designed for stimulation of erogenous zones on the anterior vaginal wall V.

In FIG. 2, a variant of the device from FIG. 1 is schematically shown in a cross-section. The first portion 11a extends from a front end 51a in the insertion direction, wherein the opening 3 is arranged in a side wall 51 of the housing 4. The second portion 11b extends from a rear end 51b. The stimulation is carried out as it is in all the exemplary embodiments described below by means of a pressure alternating field consisting of negative pressures and positive pressures, which is generated by a pressure field generation device 1 and can be directly applied to the desired area via the pressure chamber 2 and the opening 3.

The pressure field generation device 1 is coupled with a cavity referred to in the following as a pressure chamber 2, which has an outward-facing opening 3, which is designed in such a way that a pressure field in the pressure chamber 2 can be specifically applied onto an erogenous zone at the anterior vaginal wall V. By inserting the stimulation device 11, in particular the front portion 11a, into the vagina, a largely closed flow system is formed by the snuggling of the vaginal walls V onto the opening 3 of the pressure field generation device 1. In the flow system, media flows are generated, which are directed alternately to the erogenous zone at the anterior vaginal wall V and directed away from the erogenous zone at the anterior vaginal wall V. In this sealed current flow system, removal of body fluid from the pressure field generation device 1 is avoided to the furthest extent.

The pressure field generation device 1 has a moveable or flexible wall 5, which is deflected for generating the pressure alternating field. For this purpose, a corresponding drive unit 6 is provided, which is described in more detail below with reference to FIGS. 31 to 33. At least the wall 5 of the pressure field generation device consists of an elastic material, for example, silicone or rubber, wherein the flexible wall 5 is deflected by means of the drive 6 in order to cause a positive and negative volume change dV in the pressure chamber for generating the pressure field.

A sealing of the pressure chamber 2 by the adjacent vaginal walls V promotes the build-up of a pressure alternating field. Although a sealing would be achieved due to the abutting vaginal walls V in the case of an opening 3 lying flush in the housing 4 for example, a sealing device 30 is preferably provided, which runs in a ridge-like manner around the opening 3 of the pressure chamber 2. In this way, the depth of the pressure chamber 2 can also be enlarged without enlarging the entire housing 4. It has been shown that, due to the snuggling mucous membranes, a minimum size of the opening 3 and of the pressure chamber 2 is favourable in order to also ensure a sufficient air volume for the build-up of the pressure alternating field, in particular, during the negative pressure phases, the adjacent vaginal wall V is drawn into the pressure chamber 2.

Preferably for generation the pressure field, the opening 3 is circular or elliptical, wherein other shapes can also be conceivable. The opening 3 should also be large enough to cover the area to be stimulated. A diameter should, for example, not be smaller than 5 mm, preferably not smaller than 7 mm. Conversely, the opening 3 should not be too large, so that the vaginal wall V is not pulled too far into the pressure chamber 2, thereby possibly impairing the build-up of the pressure field. The diameter should therefore not be greater than 40 mm, preferably not greater than 30 mm, furthermore preferably not greater than 20 mm. In the case of an elliptical or oval shape of the opening 3, the large half-axis of the ellipse should not be less than 5 mm, preferably not less than 7 mm. The large half-axis of the ellipse should furthermore not be greater than 40 mm, preferably not greater than 30 mm, being further preferred, not greater than 20 mm.

The depth of the pressure chamber 2, i.e. the distance between the opening 3 and the flexible wall 5 in the upper dead point or with minimum volume of the pressure chamber 2 should not be less than 3 mm, preferably not less than 5 mm, further preferably not less than 7 mm.

An alternating frequency between 1 Hz to 150 Hz, preferably between 1 Hz and 125 Hz, further preferably between 1 Hz and 100 Hz has been shown as a suitable sexual stimulation of the erogenous zones at the anterior vaginal wall, at best until orgasm. Higher frequencies are perceived by users as an unpleasant pulling/cramping sensation.

The pressure differences should be at 20 mbar to 600 mbar, preferably at 20 mbar to 400 mbar, further preferable at 20 mbar to 300 mbar around the ambient pressure, wherein the pressure difference exists between the highest positive pressure and the lowest negative pressure and is preferably symmetrically arranged around an ambient pressure (usually substantially 1 bar). Smaller pressure differences than those indicated are unsuitable for stimulation of erogenous zones on the front anterior vaginal wall. Pressure differences that are greater than those indicated can lead to injury and bleeding in the inside the vagina and should therefore be avoided.

In addition to the pressure field generation device 1, the stimulation device 11 contains a control device 9 to control the drive unit 6, and in which preferably the modulation of the pressure field is pre-stored. In addition, at least one control element 10 is provided in the second portion 11b, wherein the respective modulation of the pressure field by means of the control element 10 can be changed. Preferably, the first portion 11a does not have any control elements to be operated by a user manually. These would be covered in any case if the first portion 11a of the stimulation device 11 is inserted into the vagina. Furthermore, the hygienic use of the device can be improved if no control elements are arranged in the insertable portion 11a of the device 11. Furthermore, the stimulation device 11 has a housing suitable for insertion into the vagina 4, which comprises the control device 9, the drive unit 6, the pressure field generation device 1 and an internal battery 12, wherein the stimulation device 11 as a portable handheld device. The control device 9 allows to adjust by means of a control element 10 a stimulation pattern from the stimulation patterns of the control device 9, wherein the drive unit 6 is controlled according to the set stimulation pattern.

Since, due the snuggling of the vaginal walls onto the device 11, thereby being sufficiently inserted, the opening 3 of the pressure field generation device 1 is sealed, or substantially sealed and thus forming an at least largely sealed flow system, there is virtually no air exchange with the ambient environment, which is why the removal of body fluid from the pressure field generation device 1 is avoided and the stimulation does not lead to the drying of the mucous membranes.

The temperature of the air volume enclosed in the sealed system quickly matches the body's temperature due to the volumes that are to be kept as low as possible. Optionally, a heating device can be provided. Furthermore, the stimulation device does not have any valves, which facilitates hygienic use.

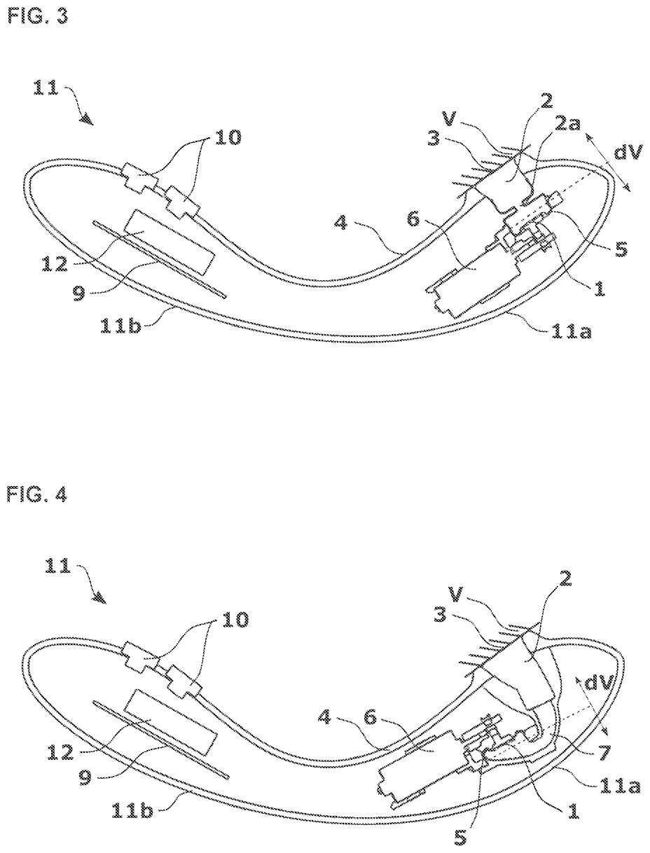

The pressure chamber 2 optionally together with a subsequent connecting portion may have a cross-sectional change in the flow direction or be designed unchanged. Due to this, for example, the schematically shown variants of the pressure chamber 2 with an unchanged cross-section as is shown in FIG. 2 or with a changed cross-section. For example, the pressure chamber 2 can be connected to a short connection piece 2a with a reduced cross-section, as is shown in FIG. 3. Between the pressure chamber 2 and the drive unit 6, a longer connecting portion with a reduced cross-section may also be provided, either as a rigid pipe or channel 7 as in FIG. 4, or in the form of a flexible hose 8 as is shown in FIG. 5. Otherwise, the variants shown in FIGS. 3 to 5 correspond to the variant shown in FIG. 2.

A cross-sectional change of the pressure chamber 2, or the pressure chamber 2 with an abutting connecting portion 2a, 7, 8, has a corresponding effect on the flow velocity of the medium, i.e. a cross-sectional narrowing means a flow acceleration and a cross-sectional extension corresponding to a flow deceleration. The embodiment with a flexible connecting portion 8, as is shown in FIG. 5, allows extensive flexibility in the arrangement of the components in the housing 4, whereby the device 11 can be designed in a particularly favourable manner for insertion into the vagina without sacrificing stimulation efficiency.

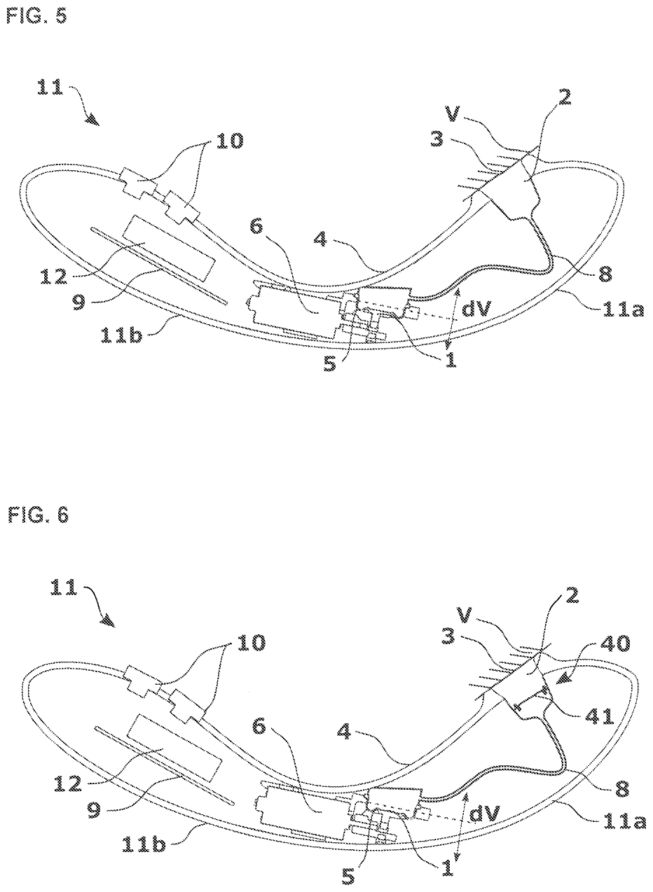

FIG. 6 shows an exemplary embodiment of an insertable stimulation device 11, which is essentially similar to the variants shown in FIGS. 2 to 5. Compared to the exemplary embodiment shown in FIG. 5, a slightly longer tube 8 is provided so that the drive unit 6 lies in the second portion 11b of the device 11, which is not inserted or is essentially not inserted into the vagina. Furthermore, a coupling device 40 is provided with a membrane 41, which couples the hose 8 with the pressure chamber 2, so that no impurities enter the hose 8 and to the moveable wall 5 to facilitate cleaning. In other words, the pressure field in the hose 8 generated by the movement of the wall 5 is transmitted via the membrane 41 into the pressure chamber 2. The coupling device 40 is described below in more detail with reference to FIG. 34.

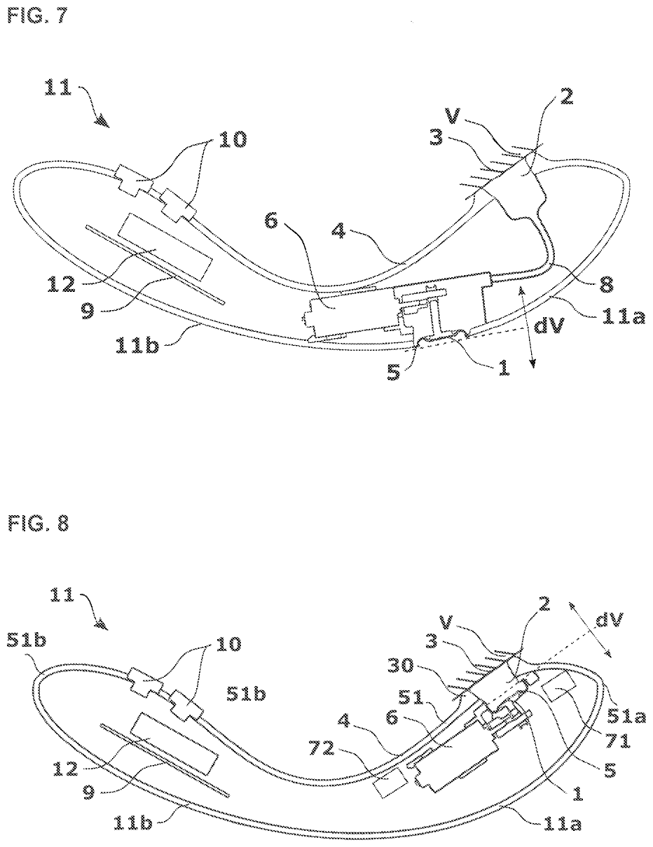

FIG. 7 shows another variant of the insertable device 11, which is principally similar to the variants shown in FIGS. 2 to 6. In this exemplary embodiment, the flexible wall 5 of the pressure field generation device 1 is integrated into the wall of the housing 4 of the stimulation device 11. In this way, the mechanical performance of the stimulation device 11 can be kept low, since, instead of (as in FIGS. 2 to 6) a closed volume on the back side, i.e. the side of the flexible wall 5 facing away from the pressure chamber 2, which requires a corresponding compression or expansion of the enclosed volume during the corresponding phases of wall 5 deflection, the ambient environment is used as a volume for the back side of the flexible wall 5. It is to be understood that the position of the flexible wall 5 should be preferably chosen in such a way that the wall 5 is essentially freely exposed during operation or is at least not limited in its movement due to abutting mucous membranes or otherwise by the user.

FIG. 8 shows another variant of the insertable device 11, which is principally similar to the variants shown in FIGS. 2 to 7. While the arrangement of the components shown in FIG. 8 corresponds to those from FIG. 2, it is understood that all variants shown above with reference to FIGS. 2 to 7 are possible.

In this exemplary embodiment, the stimulation device 11 has a sensor device 70, which comprises proximity sensors 71, 72 in order to enable an automatic or semi-automatic control of the device 11. In general, the sensor device 70 can comprise at least one proximity sensor 71, 72, which is configured to detect a proximity to a portion of the human body. Proximity is understood to refer to a very short distance of a maximum of a few millimetres away from a portion of the body as well as a contact with a portion of the body. The proximity sensor 71, 72 can be coupled with the control unit 9 and the control unit 9 can be configured to start the generation of the pneumatic pressure alternating field and the generation of the pneumatic pressure alternating field when detecting a proximity to a portion of the human body and the generation of the pneumatic pressure alternating field when no proximity to a portion of the human body is detected. Corresponding electrical control signals are sent from the sensor device 70 to the control unit 9 and from the control unit 9 to the drive unit 6.

Preferably, as is shown in FIG. 8, two (or a plurality of) proximity sensors 71, 72 can be provided. In order in particular to detect an insertion of the device 11, these are advantageously arranged along the insertion direction of the first portion 11a spaced apart from each other, preferably before or behind the opening 3 of the pressure chamber 2. The control unit 9 is then preferably configured to start generating the pneumatic pressure alternating field if all of the proximity sensors 71, 72 detect a proximity to a portion of the human body, and to stop the generation of the pneumatic pressure alternating field when at least one of the proximity sensors 71, 72 does not detect any proximity to a portion of the human body. In this way, it is ensured that the generation of the pressure alternating field is only then activated if the opening 3 is completely located inside the vagina.

The proximity sensor or the proximity sensors 71, 72 can be capacitive sensors, optical sensors or acoustic sensors, which are suitable to detect a proximity to a portion of a human body. The proximity sensor 71, 72 is preferably arranged in the first portion 11a of the stimulation device 11 so that it is positioned in the operation of the device 11 inside the human body. Preferably, all the proximity sensors 71, 72 are arranged in the first portion 11a in such a way. However, it may also be provided that at least one of the sensors is arranged in the second portion 11b of the stimulation device 11, which remains outside the body and detects a proximity to an external portion of the human body, for example, even if the second portion 11b is grasped or enclosed using the hand.

Due to the control by means of proximity sensor 71, 72, an automatic switching on and off of the device 11 can be achieved. This can, for example, be desirable for the purpose of reducing noise and/or energy consumption. For example, the device 11 can be moved into a “standby mode” when switching on by the user operating a control element 10. The generation of the pressure alternating field can then be controlled by means of the proximity sensors 71, 72, so that the device 11 is active only if it is inserted deep enough into the body. In this standby mode, the stimulation device 11 is in operation, since the user has switched it on, however, the drive unit 6 is powerless, thus the stimulation device 11 does not generate a pressure field. In addition, the sensor device 70 is in standby mode during operation and carries out measurements or estimations at regular intervals.

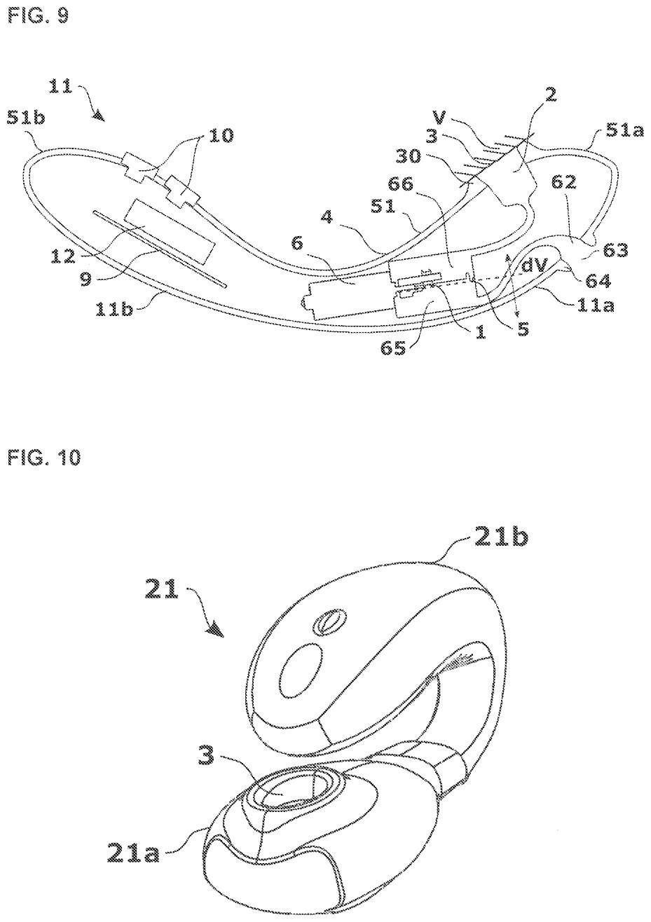

FIG. 9 shows another variant of the insertable device 11. To this extent that the variant shown in FIG. 9 corresponds to one of the variants shown in FIGS. 2 to 8, reference is made to the description above. In addition to the pressure chamber 2, another pressure chamber 62 with an opening 63 is also provided in the insertable portion 11a, which can be used, for example, for the simultaneous stimulation of another area inside the vagina. A sealing device 64 is arranged around the opening 63 in order to seal the second pressure chamber 62 against the ambient environment. The first pressure chamber 2 and second pressure chamber 62 are independent of each other, since the moveable wall 5 separates two volumes from each other, wherein the one volume is connected to the first pressure chamber 2 to generate a corresponding first pressure alternating field in the first pressure chamber 2, and the other volume is connected to the second pressure chamber 62 to produce a corresponding second pressure alternating field in the second pressure chamber 62. This means that the build-up of a pressure alternating field in the first pressure chamber 2 or second pressure chamber 62 also takes place even if the other pressure chamber is not or not sufficiently sealed against the ambient environment or substantially sealed. The additional stimulation by means of the second pressure chamber 62 can thereby be optionally used. If the second pressure chamber 62 is not sealed or substantially sealed, the back side of the moveable wall 5, i.e. the side of the wall 5 away from the pressure chamber 2 can be considered “ventilated”, i.e. open to the ambient environment, as in the variant according to FIG. 7 so that corresponding advantages regarding a reduced performance of the drive unit 6 result.

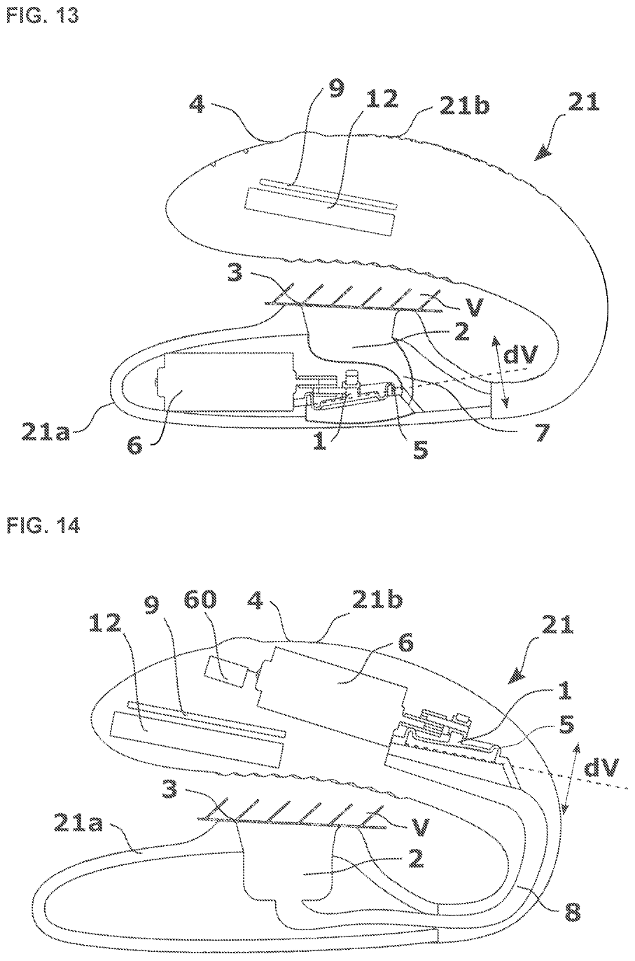

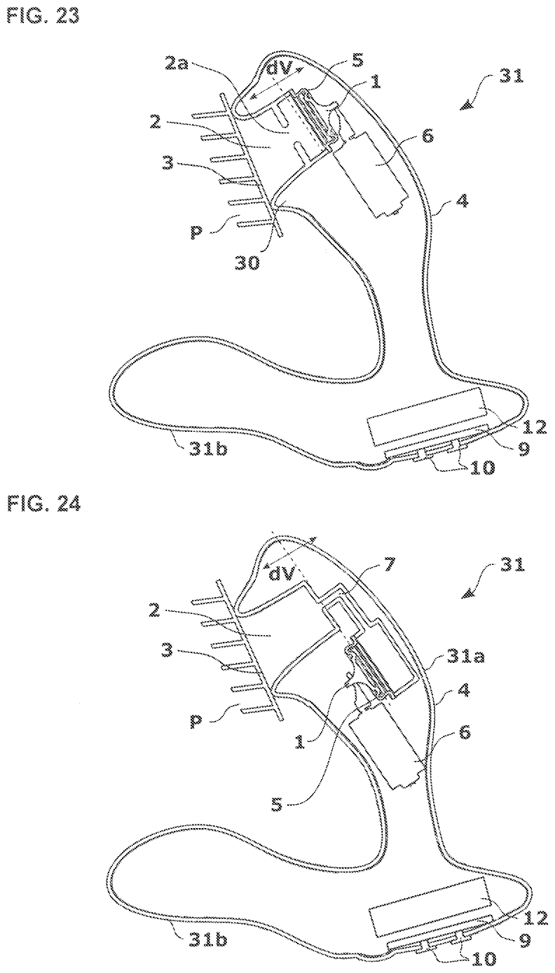

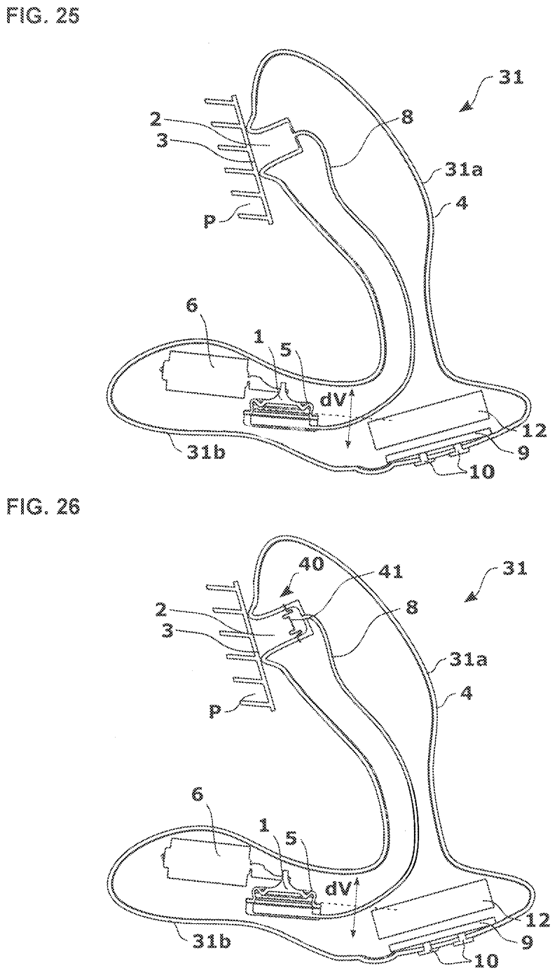

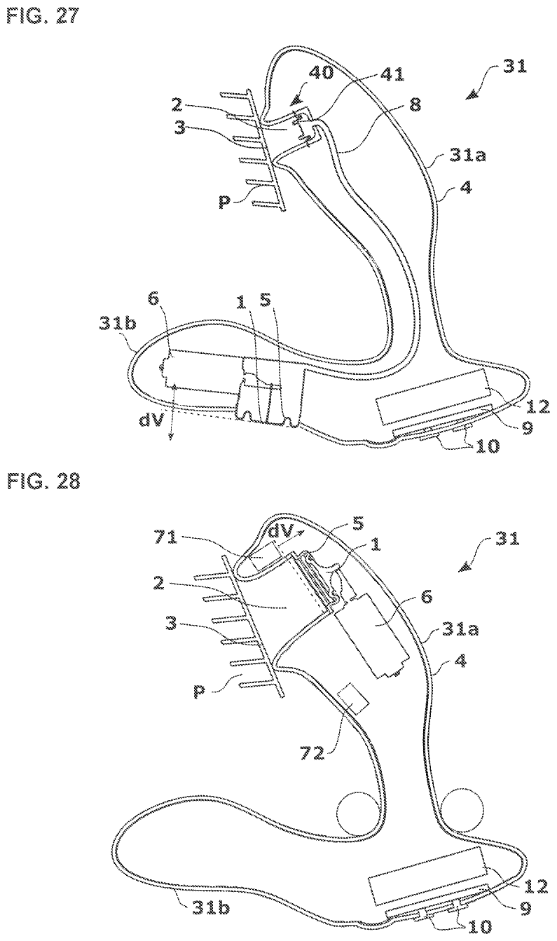

The preceding descriptions apply analogously to the following exemplary embodiments of a vaginally insertable dual stimulation device (FIGS. 10 to 20) and an anally insertable stimulation device (FIGS. 21 to 30). Corresponding components, for example, the pressure field generation device 1, the drive unit 6 or the control unit 9 are correspondingly provided with the same reference numbers, wherein reference is made to the above description.

FIG. 10 shows an exemplary embodiment of an insertable device 21 for the dual stimulation of erogenous zones on the anterior vaginal wall V by means of a pressure field generation device 1 with simultaneous clitoral stimulation.

In FIG. 11, a first variant of the device 21 is schematically shown in a cross-section. The device 21 has a first portion 21a for insertion into the vagina with a front end in the insertion direction 52a and a side wall 52 for contacting the vaginal wall V, and a second portion 21b with a rear end 52b, which is dimensioned in order to contact the clitoris saliva be inserted after insertion of the first portion 21a to contact the clitoris glans. The first portion 21a and the second portion 21b are connected by a curved intermediate portion 21c so that first portion 21a and the second portion 21b run at least partially side by side so that the device 21 can be viewed overall as C-, V- or U-shaped, wherein a relative position of the first portion 21a and the second portion 21b can be adjustable, for example, by means a corresponding flexibility of the intermediate portion 21c or by providing one or a plurality of joints or hinges (not shown). Therefore, the device 21 can also be used, if applicable, without the use of hands after insertion of the first portion 21a due to the clamping effect. The first portion 21a can be relatively flat in order to allow for simultaneously sexual intercourse with a male partner.

The device 21 is inserted into the vagina with the first portion 21a to the intermediate portion 21c. The control unit 9 is located in the portion 21b not inserted into the vagina during use. The clitoral stimulation can be generated tactilely by means of a vibration or alternatively also by means of a pressure field acting on the clitoris glans, as described in more detail below. The opening 3 of the pressure chamber 2 in the first portion 21a is facing the second portion 21b so that the opening 3 is orientated against an anterior inner wall V of the vagina. Apart from that, with regard to functionality, the structure and the arrangement of the individual components, reference is made to the description above.

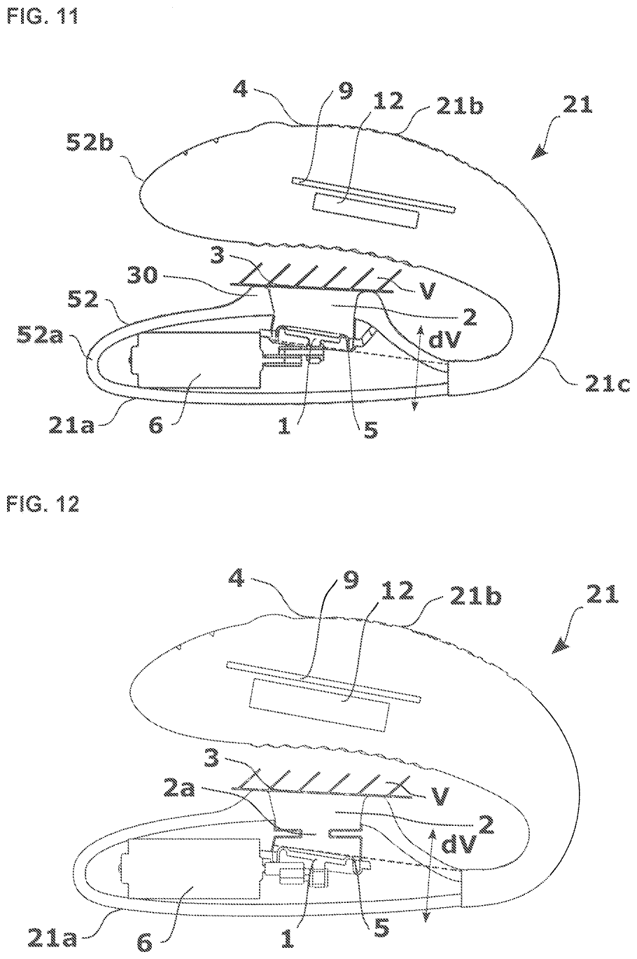

The variants shown in FIGS. 12 to 20 can correspond to the variants of FIGS. 3 to 9. In particular, with respect to the arrangement of the components of the pressure field generation device 1, FIGS. 2 and 11, FIGS. 3 and 12, FIGS. 4 and 13, FIGS. 5 and 14 and FIGS. 6 and 15 correlate.

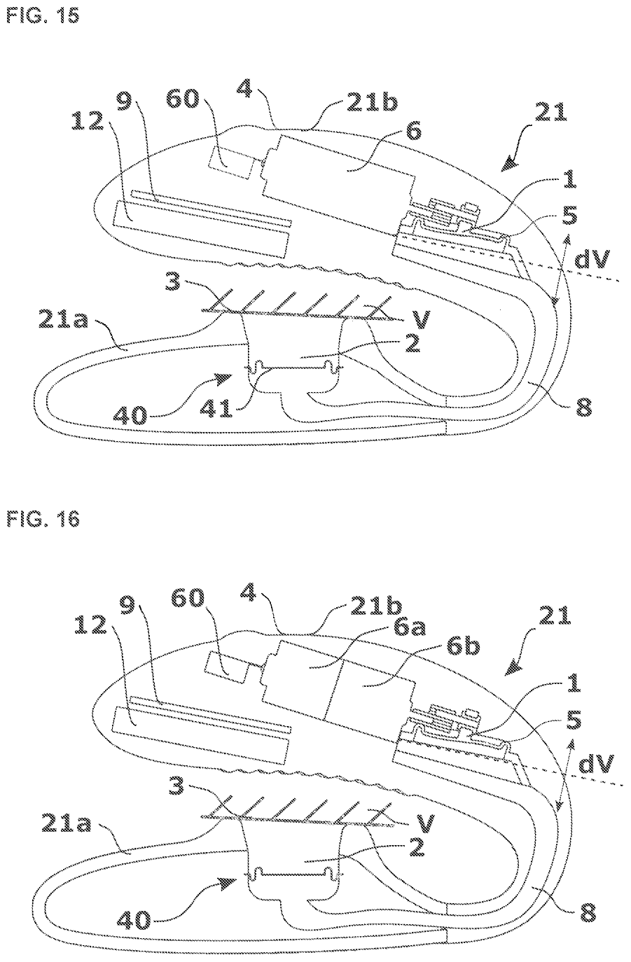

The clitoral stimulation as is shown in FIGS. 14 and 15 is generated in a tactile manner by a vibrating unit 60 by means of a vibration by an electric motor with an unbalanced mass. The electric motor can be that of the drive unit 6 and have two shaft ends, wherein the one shaft end creates the flexible wall 5 of the pressure field generation device 1 for changing the volume for the pressure field for vaginal stimulation and the other shaft end creates the unbalanced mass for the generation of the mechanical vibration of the external portion 21b.

As an alternative to design in FIGS. 14 and 15, instead of an electric motor with two shaft ends, two electric motors 6 and 6a can also be used, for example, back-to-back, as is shown in FIG. 16.

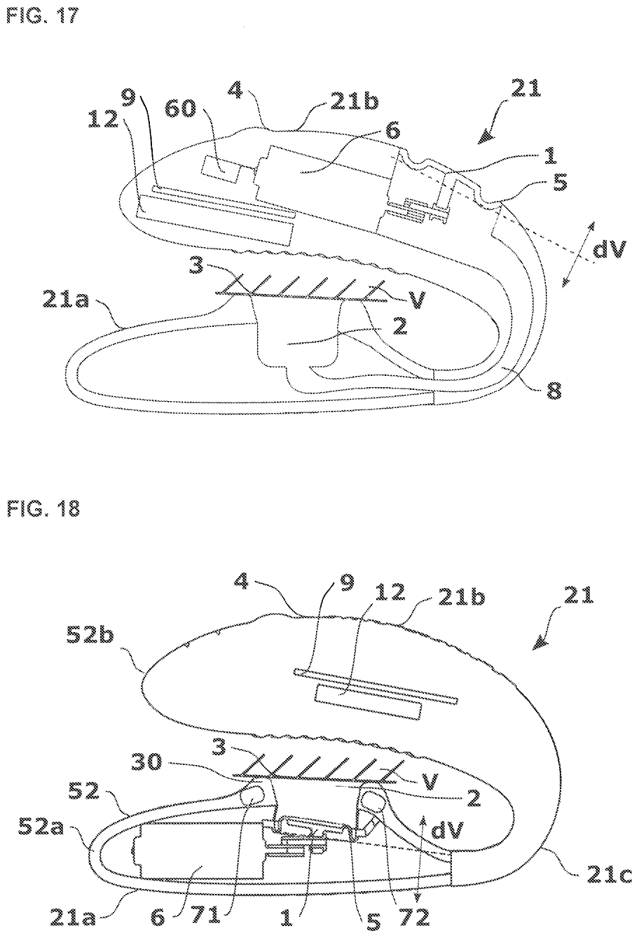

The exemplary embodiment shown in FIG. 17 corresponds to the exemplary embodiment shown in FIG. 7 with regard to the structure of the pressure field generation device 1. In order to keep the mechanical performance of the dual, compact stimulation device 21 with limited housing volume low, the flexible wall 5 is integrated in this variant directly into the housing 4 of the stimulation device 21. By means of this, the ambient environment for the back side of the flexible wall 5 is used by integrating the flexible wall 5 into the external portion 21b located outside the vagina.

FIG. 18 shows an exemplary embodiment of a stimulation device 21 with proximity sensors 71, 72. Reference is made to the description of FIG. 8 above accordingly.

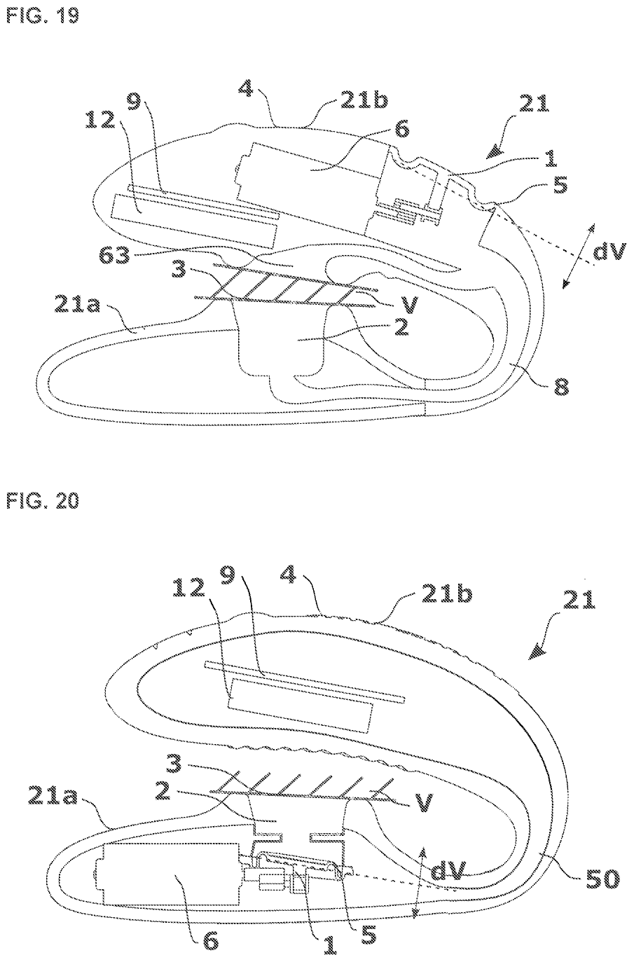

FIG. 19 shows an exemplary embodiment of an insertable device 21, which is substantially similar to the exemplary embodiment shown in FIG. 17. Furthermore, like in the variant according to FIG. 9, in addition to the pressure chamber 2 in the insertable portion 21a, another pressure chamber 62 with an opening 63 and corresponding seal 64 is provided in the second portion 21b for simultaneous clitoral stimulation by means of another pressure field. In FIG. 19, the pressure field generation device 1 of the dual stimulation device 21 is used in order to generate two pressure fields, which are applied to the vagina and the clitoris. By using a single pressure field generation device 1, the two pressure fields in amplitude and frequency are not independent of each other, but the device 21 can be designed in a compact manner. This means that, due to the interrelated cavities, both pressure chambers 2, 62 must be sealed against the ambient environment or substantially sealed to allow the build-up of a pressure alternating field in the pressure chambers 2, 62. As soon as one of the pressure chambers 2, 62 is not or insufficiently sealed or substantially sealed, no corresponding pressure alternating field can also be built up in the other pressure chamber. Alternatively, a second pressure field generation device with the corresponding components for the generation of an independent pressure field for the second pressure chamber 62 can be provided, or as in FIG. 9 the moveable wall 5 can be used to separate the two pressure chambers 2, 62.

FIG. 20 shows another variant of an insertable device 21 for stimulation of erogenous zones on the anterior vaginal wall V by means of a pressure field generation device 1. The structure otherwise corresponds to the exemplary embodiment shown in FIG. 12. It is to be understood that a combination with any other variant of the pressure field generation device 1 is possible. A cavity 50, for example, by means of a hollow element guided through the intermediate portion 21c, is provided for increasing the volume on the back side of the flexible wall 5. Similar to the variant shown in FIG. 17, in which the moveable wall 5 is freely exposed to the ambient environment, the required mechanical power for compression and expansion of the air volume on the back side, meaning the side of the wall 5 facing away from the pressure chamber 2, can be reduced by means of this in comparison to the mechanical power for generating the pressure field without such a volume expansion so that the inner portion 21a is designed in a compact manner and compact and lightweight components (e.g. electric motor) of the drive unit 6 can be used for generating the pressure field. In particular, due to such a structure of the stimulation device 21, the first portion 21c can be designed so compactly as to enable or facilitate the use of the device 21 during simultaneous sexual intercourse with a male partner.

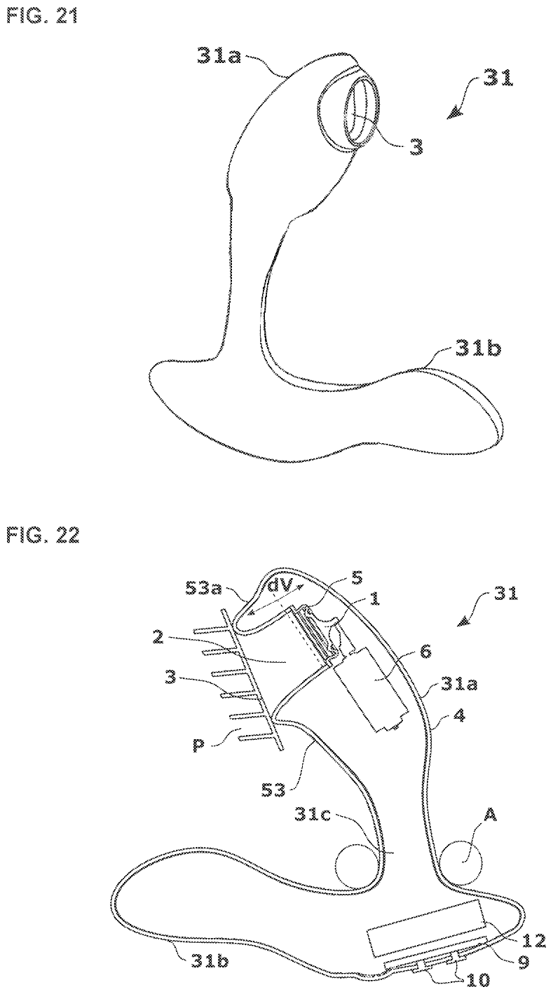

FIG. 21 shows an exemplary embodiment of a device that can be inserted into a rectum 31, in particular, for use by a male user for stimulation of the prostate P by means of a pressure field generation device 1. FIG. 22 shows a schematic cross-section of a variant of the device 31. The device 31 from FIG. 22 corresponds to the device 11 shown in FIG. 2 with regard to the generation of a pressure alternating field. To this extent, reference is also made to the description above.

The device 31 has a first portion 31a with a front end 53a in the insertion direction for insertion into the rectum and for stimulating the prostate P via the adjacent intestinal wall as well as a second portion 31b, which is positioned outside the rectum at the perineum between rectum and scrotum, thereby preventing the sphincter A from pulling the device 31 too far into the rectum. The first portion 31a essentially extends vertically, for example, to form a T-shape, wherein a relative position of the first portion 31a and the second portion 31b can be adjustable, for example, by providing a corresponding flexibility or one or a plurality of joints or hinges (not shown). If applicable, an intermediate portion 31c, which connects the first portion 31a and the second portion 31b, can offer a corresponding functionality. The intermediate portion 31c can also have a smaller diameter than the first portion 31a and the second portion 31b to allow for a holding of the device 31 by the sphincter A.

To facilitate the reaching of the prostate P with the opening 3, which is arranged in a side wall 53 of the insertable portion 31a, the insertable portion 31a should be appropriately dimensioned and, if applicable, flexibly designed. The insertable portion 31a can be designed, for example, in its length and in its orientation relative to the second portion 31b adjustable, so that the pressure field can have an optimal effect on the prostate P according to the respective user anatomy. The length and/or the orientation can be manually adjustable or also by means of a remote control. The device 31 can be used after insertion without using hands, for example, by the user sitting down.

Other descriptions regarding pressure field amplitude and frequency, as well as pressure chamber dimensions are analogous to the insertable device 11 for stimulation of erogenous zones on the anterior vaginal wall (FIGS. 1 to 9). The variants shown in FIGS. 22 to 28 can correspond to the variants of FIGS. 2 to 8. In particular, with respect to the arrangement of the components of the pressure field generation device 1, FIGS. 2 and 22, FIGS. 3 and 23, FIGS. 4 and 24, FIGS. 5 and 25, FIGS. 6 and 26, FIGS. 7 and 27, and FIGS. 8 and 28 correlate.

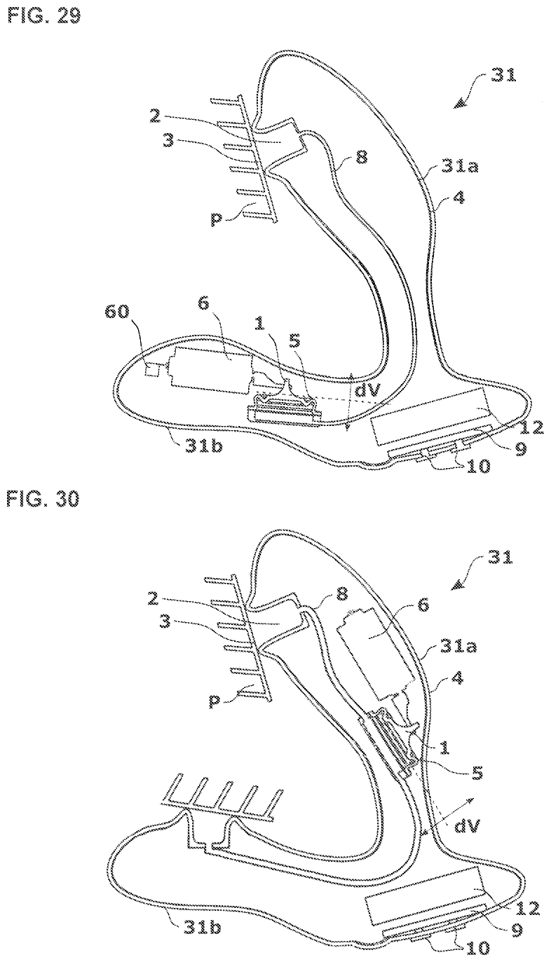

In accordance with the exemplary embodiment of the stimulation device 21 shown in FIGS. 14 to 16, the device 31 can also be provided with a vibrating unit 60 for insertion into the rectum in order to provide a tactile stimulation of the perineum or of the anus, as is shown in FIG. 29.

In accordance with the exemplary embodiments of the device 11 or 21 shown in FIGS. 9 and 19, another stimulation can also be provided in the device 31 by means of another pressure field, as is shown in FIG. 30. For this purpose, another pressure chamber 63 is formed in the second portion 31b. In order to achieve an improved or at all sufficient sealing of the pressure chamber 62 compared to the ambient environment, a corresponding sealing device 64 can be provided, which is pressed against the skin of the perineum. A sealing of the second pressure chamber 62 can also take place here, in particular, by the user sitting down.

With reference to FIGS. 31 to 33, a drive unit 6 of the pressure field generation device 1 is described as an example, which can be used in any of the exemplary embodiments in FIGS. 1 to 30 described above. The mechanical power required to generate the pressure field is determined by the volume of the pressure chamber 2 of the pressure field generation device 1, the volume change dV and the frequency of this change as long as the volume on the back side of the flexible wall 5 in the housing 4 of the pressure field generation device 1 is large enough. In this case, the mechanical power required for compression and expansion of the air volume on the back side, i.e. the side of the wall 5 in the housing 4 facing away from the pressure chamber 2 is negligible even at a good proximity compared to the mechanical power for generating the pressure field in the pressure field generation device.

However, if a compact design of the housing 4 is desired, due to the resulting smaller volume on the back side of the moveable wall 5 more power may be necessary to compress or expand this volume. In order to keep the mechanical performance low even with a compact design of the housing and to be able to use a correspondingly compact and lightweight drive unit 6, the flexible wall 5 can be directly integrated into the housing 4 of the stimulation device as is shown, for example, in FIG. 7, 17 or 27, in order to use the ambient environment as a volume for the back side of the flexible wall 5. In order to use the ambient environment as a volume for the back side, the flexible wall portion 5 must preferably lie outside the body. So that the movement of the wall 5 is not disturbed by the user, the wall 5 can, for example, be covered by an element that is impermeable to air.

The drive unit 6 coupled to the flexible wall 5 of the pressure field generation device 1 can consist, for example, of a rotating electric motor 13 with mechanical transmission. The mechanical transmission of the rotation of the electric motor 13 into a translational movement of the flexible wall 5 of the pressure field generation device 1 can be carried out, for example, by means of an eccentric 14, as is schematically shown in FIG. 31.

By the control current supplied to the rotating electric motor 13 in the form of direct current, the speed of the electric motor and thus ultimately the frequency of the flexible wall 5 is varied or controlled. The flexible wall 5 can have a ridge, which follows the strokes of the flexible wall mechanically to the furthest extent possible without mechanical strains. The stroke of the flexible wall 5 is determined by the defined eccentric path. The fixed piston stroke means a fixed reduction and increase of the chamber volume dV and thus, correspondingly a fixed pressure increase or pressure reduction, i.e. a substantially fixed amplitude of the alternating positive and negative pressure. Different amplitudes of the alternating negative and positive pressure cannot be set at the erogenous zones using the described drive unit. In addition, the minimum frequency is limited, since the friction torque of the crank drive as well as the rotating electric motor (i.e. bearing and brush friction of the permanent magnet-excited-dc-motor) must be exceeded.

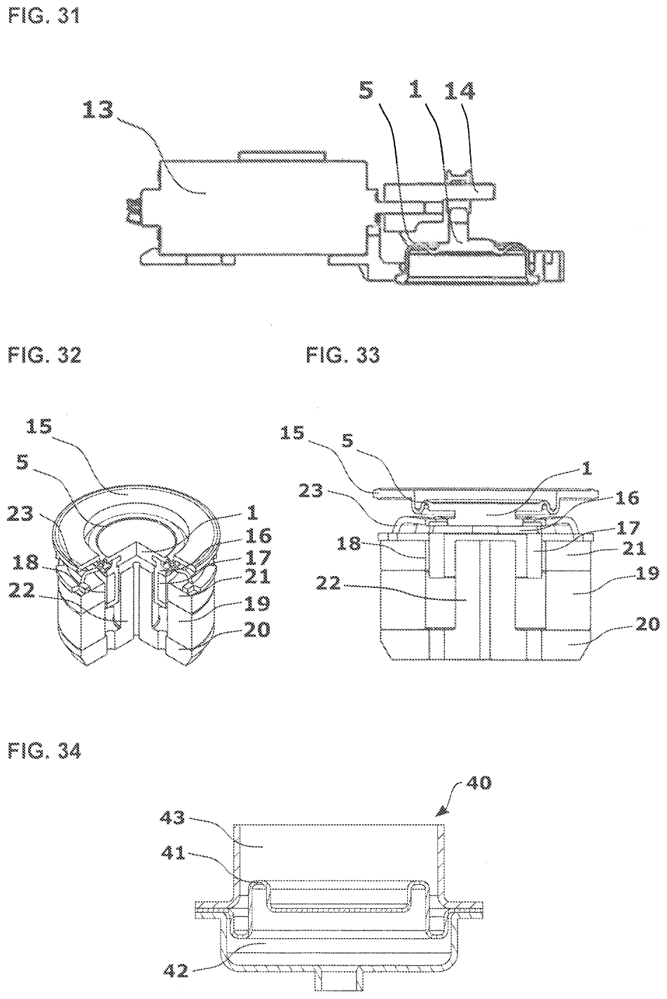

Alternatively, the drive unit 6 coupled to the flexible wall 5 of the pressure field generation device 1 can consist of a linear electric motor 15, as in FIGS. 32 and 33. In the illustrated electromagnetic converter, the flexible wall 5 is connected to a carrier 16 by with at least one attached to it vibrating or immersion coil 17 according to the coil supply by means of the control current in the air gap 18 moved back and forth.

The flexible wall 5 of the pressure field generation device 1 is attached to a carrier 16. The flexible wall 5 can have a groove, which follows the strokes of the flexible wall mechanically to the furthest extent possible without mechanical strains. An oscillating coil 17, which is supplied with control current from a control unit during operation, is wrapped around the carrier 16. The oscillating coil 17 consists of electrically conductive material (preferably copper), which are insulated with an electrically insulating lacquer against each other and against the carrier 16. The magnetic field is generated by at least one permanent magnet 19, preferably with a ring shape like in FIGS. 32 and 33.

The magnetic flux is, for example, guided by means of a rear pole plate 20 (preferably being cylindrical in shape as is shown in FIGS. 32 and 33) to the cylindrical pole core 22 via the upper pole plate 21 (preferably with a ring shape as is shown in FIGS. 32 and 33) across the preferably ring-shaped air gap. Rear 20 and upper pole plate 21 just like the pole core 22 are made of magnetically high permeable material (preferably a soft magnetic material alloy). As an alternative, a cylindrical permanent magnet can be used instead of the pole core 22 and, correspondingly, a ring pole can be used instead of the permanent magnet 19.

The carrier 16 with the oscillating coil 17 is constructively centred by at least one mount or suspension 23 (preferably made of plastic, textile fabric or paper) in the air gap 18 and guided to prevent tumbling movements of the oscillating coil 17. The mount or suspension 23 is attached to a frame.

In order to move the flexible wall 5, the oscillating coil 17 is supplied with a control alternating current from a control unit. Due to Lorentz force, the oscillating coil 17 is moved upwardly or downwardly depending on the current direction or current polarity in the magnetic field of the air gap 18. The stroke of the deflection of the oscillating coil is determined by the amplitude of the control current. The frequency of the alternating current corresponds to the frequency of the oscillating coil movement and thus of the frequency of the piston or membrane movement. The frequency and the stroke of the oscillating coil and thus the movement of the flexible wall 5 can thus be controlled comparatively easily by the current frequency and current amplitude independently of each other. Due to the direct transmission, an expanded frequency range with this principle of under 1 Hz up to several hundred Hz is possible. The direct current from the accumulator must also be converted into an alternating current signal.

Alternatively, the coil can be fed with any signal form (e.g. sine, triangle, rectangle, sawtooth signal or with any form of an analogue signal) of a polarity, provided that the linear drive is mechanically configured accordingly. Furthermore, the coil can also be supplied with a sine-pulse-width modulation.

FIG. 34 shows a coupling device 40, as it is, for example, contained in the exemplary embodiments in FIGS. 6, 15, 16, 26 and 27. The coupling device 40 has a membrane 41, which divides a cavity of the coupling device 40 into two chambers 42, 43, so that no fluid or generally contamination can enter the chamber 43 into the chamber 42. A pressure change, in particular due to the pressure field generated by the pressure field generation device 1 causes a deflection of the membrane 41, so that the pressure alternating field is transmitted despite the prevention of a fluid flow. In particular, a pressure alternating field in a connecting portion, such as a hose 8, can be transmitted into the pressure chamber 2 via the membrane 41, while the membrane 41 simultaneously prevents, for example, body fluids or impurities from entering from the pressure chamber 2 into the connecting portion 8 in the direction towards the moveable wall 5. The coupling device 40 allows the implementation of an extended and flexible connecting element, for example, a hose 8, simultaneously having hygienic design, i.e. cavities in which bodily fluid can accumulate, which are difficult to access and thus difficult to clean, are avoided.

Since, on the one hand, the chamber 42 borders the membrane 41 and, on the other hand, (if necessary, via a connecting portion 8) borders the moveable wall 5, the chamber (and, if applicable, the connecting portion 8) is also filled with a fluid, such as water, gel, or the like instead of a gas, such as air, in order to provide hydraulic transmission of the pressure alternating field onto the membrane 41 instead of a pneumatic transmission. In order to prevent the provision of liquids in cavities of the stimulation device, pneumatic transmission is however preferred.

It is to be understood that any aspects of the preferred exemplary embodiments described above can be combined with each other in any way. In particular, the preferred exemplary embodiments are only examples. For example, various aspects, such as the pressure chamber, the opening or the pressure field generation device can be combined in any way to create an inventive stimulation device for stimulating an area inside the human body. In particular, features of the various stimulation devices for the female body for insertion into a vagina and for the male body for insertion into a rectum can be combined in an appropriate way to reach and to stimulate a desired area to be stimulated inside the body.

1. A stimulation device for stimulation of an area inside a human body, the stimulation device comprising:
a first portion configured to at least partially be inserted into the human body;
a pressure field generation device configured to generate a pressure alternating field; and
a pressure chamber coupled with the pressure field generation device, the pressure chamber configured to accommodate the pressure alternating field generated by the pressure field generation device,
wherein the pressure chamber is disposed in the first portion and includes an opening formed in the first portion, the pressure alternating field in the pressure chamber to be applied via the opening to the area to be stimulated inside the human body.

2. The stimulation device of claim 1, further including a sealing device formed on the first portion and configured to seal the pressure chamber against an ambient environment.

3. The stimulation device of claim 1, wherein a diameter of the opening is greater than or equal to 5 mm.

4. The stimulation device of claim 1, wherein the pressure chamber has a minimum depth of greater than or equal to 3 mm.

5. The stimulation device of claim 1, wherein the pressure field generation device is configured to generate the pressure alternating field with an alternating frequency from 1 Hz to 150 Hz.

6. The stimulation device of claim 1, wherein the pressure field generation device is configured to generate the pressure alternating field with a pressure difference between a lowest negative pressure and a highest positive pressure of 20 mbar to 600 mbar.

7. The stimulation device of claim 1, wherein the pressure field generation device includes an electric drive unit and a moveable element coupled with the drive unit, the moveable element to move to generate the pressure alternating field.

8. The stimulation device of claim 7, wherein the drive unit and the moveable element are each at least partially disposed in the first portion.

9. The stimulation device of claim 1, further including a second portion configured to at least partially be disposed outside the human body when the first portion is at least partially inserted into the human body.

10. The stimulation device of claim 7, wherein the drive unit and the moveable element are each at least partially disposed in the first portion, the pressure field generation device and the pressure chamber fluidically coupled via a connecting portion.

11. The stimulation device of claim 9, wherein the first portion are adjustable relative to the second portion.

12. The stimulation device of claim 9, wherein the first portion is configured to be disposed at a first angle relative to the second portion, the first portion opposite the second portion and the opening of the pressure chamber in the first portion facing towards the second portion when the first portion is at the first angle.

13. The stimulation device of claim 9, wherein the first portion (31a) extends substantially perpendicularly from the second portion (31b).

14. The stimulation device of claim 1, wherein the first portion is configured to be at least partially inserted into a vagina of the human body, the pressure alternating field to be applied via the opening onto an area of an inner wall of the vagina.

15. The stimulation device of claim 1, wherein the first portion is configured to be at least partially inserted into a rectum of the human body, the pressure alternating field to be applied via the opening to an area of an intestinal wall of the rectum adjacent to a prostate of the human body.

16. The stimulation device of claim 1, wherein a diameter of the opening is greater than or equal to 7 mm.

17. The stimulation device of claim 1, wherein a diameter of the opening is smaller than or equal to 30 mm.

18. The stimulation device of claim 1, wherein the pressure chamber has a minimum depth of greater than or equal to 7 mm.

19. The stimulation device of claim 1, wherein the pressure field generation device is configured to generate the pressure alternating field with an alternating frequency from 1 Hz to 100 Hz.

20. The stimulation device of claim 1, wherein the pressure field generation device is configured to generate the pressure alternating field with a pressure difference between a lowest negative pressure and a highest positive pressure of 20 mbar to 300 mbar.

21. The stimulation device of claim 1, wherein the pressure field generation device is configured to generate the pressure alternating field with a pressure difference between a lowest negative pressure and a highest positive pressure, the lowest negative pressure having a first value below an ambient pressure and the highest positive pressure having a second value above the ambient pressure, the amount of the first value equal to the amount of the second value.

22. The stimulation device of claim 1, wherein the pressure field generation device is configured to cause the pressure alternating field to modulate between a first pressure and a second pressure, the first pressure above an ambient pressure and the second pressure below the ambient pressure.

23. The stimulation device of claim 15, wherein the pressure alternating field is to be at least partially be applied to the prostate via the intestinal wall.
